(19) United States
(12) Patent Application Publication
(10) Pub. No.: US 2025/0323995 A1
(43) Pub. Date: Oct. 16, 2025

(54) INTERACTION PROCESSING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Sha SHA, Shenzhen (CN); Yang ZENG, Shenzhen (CN); Liqiang LIU, Shenzhen (CN); Xianmin XIAO, Shenzhen (CN)

(21) Appl. No.: 19/248,146

(22) Filed: Jun. 24, 2025

Related U.S. Application Data
(63) Continuation of application No. PCT/CN2024/088821, filed on Apr. 19, 2024.

(30) Foreign Application Priority Data
Jun. 16, 2023 (CN) 202310724118.8

(51) Int. Cl. H04M 1/72436; H04L 51/046; H04L 51/10; H04L 51/52

(52) U.S. Cl. CPC H04M 1/72436; H04L 51/046; H04L 51/10; H04L 51/52; H04M 2201/42

(57) ABSTRACT

An interaction processing method includes: displaying multimedia information to be edited; displaying at least one virtual avatar of at least one object; displaying synthesized multimedia information in response to that one of the at least one virtual avatar is in a selected state, the synthesized multimedia information being obtained by adding the virtual avatar in the selected state to the multimedia information to be edited; and transmitting the synthesized multimedia information, and transmitting a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

### CROSS-REFERENCES TO RELATED APPLICATIONS

This application is a continuation of PCT Application No. PCT/CN2024/088821, filed on Apr. 19, 2024, which claims priority to Chinese Patent Application No. 202310724118.8, filed on Jun. 16, 2023, the entire contents of both of which are incorporated herein by reference.

### FIELD OF THE TECHNOLOGY

The present disclosure relates to the field of human-computer interaction technologies, and in particular, to an interaction processing method and apparatus, an electronic device, and a computer-readable storage medium.

### BACKGROUND OF THE DISCLOSURE

In some social information flow product or some instant messaging product, if a user wants to post an image to a social network or transmit an image to a group chat, the user may edit a text for reminding a person (such as @someone) when posting the image or transmitting the image, so that content posted by the user is known by the person, or select a friend to be reminded from a list of options, thereby implementing a strong reminding function. However, such reminding method has a long and dull process, and a final presentation effect is merely a reminder text. Redundancy of the human-computer interaction process causes a problem of low human-computer interaction efficiency and redundancy of the reminder text causes a problem of low display resource utilization rate.

### SUMMARY

Embodiments of the present disclosure provide an interaction processing method and apparatus, an electronic device, a computer-readable storage medium, and a computer program product, which can implement a reminding function by using improvement of a virtual avatar, thereby improving the human-computer interaction efficiency and the display resource utilization rate.

Technical solutions of the embodiments of the present disclosure are implemented as follows:

An embodiment of the present disclosure provides an interaction processing method, the method being performed by an electronic device, and including: displaying multimedia information to be edited; displaying at least one virtual avatar of at least one object; displaying synthesized multimedia information in response to that one of the at least one virtual avatar is in a selected state, the synthesized multimedia information being obtained by adding the virtual avatar in the selected state to the multimedia information to be edited; and transmitting the synthesized multimedia information, and transmitting a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

An embodiment of the present disclosure provides an interaction processing apparatus, including: a display module, configured to display multimedia information to be edited; and display at least one virtual avatar of at least one object; and an editing module, configured to display synthesized multimedia information in response to that one of the at least one virtual avatar is in a selected state, the synthesized multimedia information being obtained by adding the virtual avatar in the selected state to the multimedia information to be edited; and a transmitting module, configured to transmit the synthesized multimedia information, and transmit a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

Embodiments of the present disclosure provide an interaction processing method, performed by an electronic device, the method including: receiving a reminder message by using a client of a target object; displaying synthesized multimedia information in response to a trigger operation for the reminder message, the synthesized multimedia information including a virtual avatar of the target object; and displaying, on the synthesized multimedia information and in response to a commenting operation by the target object on the synthesized multimedia information, comment information corresponding to the virtual avatar of the target object.

An embodiment of the present disclosure provides an electronic device, including: a memory, configured to store a computer-executable instruction; and a processor, configured to implement the interaction processing method according to the embodiments of the present disclosure by executing the computer-executable instruction stored in the memory.

An embodiment of the present disclosure further provides a non-transitory computer-readable storage medium, having a computer-executable instruction stored therein, and the computer-executable instruction implementing, when executed by a processor, implementing the interaction processing method provided in the embodiments of the present disclosure.

The embodiments of the present disclosure have the following beneficial effects:

According to the embodiments of the present disclosure, multimedia information to be edited and a virtual avatar of at least one object are displayed, synthesized multimedia information obtained by adding a virtual avatar in a selected state to the multimedia information to be edited is displayed in response to that the at least one virtual avatar is in the selected state, which is equivalent to achieving a visual effect of being in a same frame with the virtual avatar of the object by editing the multimedia information, and subsequently a reminder message is also transmitted to the object to which the virtual avatar included in the synthesized multimedia information pertains during transmitting of the synthesized multimedia information, so as to remind the target object to view the synthesized multimedia information. That is, a reminding operation can be replaced by adding the virtual avatar. Therefore, the human-computer interaction efficiency is effectively improved while the visual effects are enriched.

### BRIEF DESCRIPTION OF THE DRAWINGS

FIG. 1A and FIG. 1B are schematic diagrams of an interface of an interaction processing method in the related technology.

FIG. 2 is a schematic structural diagram of an interaction processing system according to an embodiment of the present disclosure.

FIG. 3 is a schematic structural diagram of an electronic device according to an embodiment of the present disclosure.

FIG. 4A to FIG. 4D are a schematic flowchart of an interaction processing method according to an embodiment of the present disclosure.

FIG. 5 is a schematic flowchart of an interaction processing method according to an embodiment of the present disclosure.

FIG. 6A to FIG. 6E are schematic diagrams of interfaces of an interaction processing method according to an embodiment of the present disclosure.

FIG. 7 is a schematic logic diagram of an interaction processing method according to an embodiment of the present disclosure.

FIG. 8 is a schematic diagram of an interface of an interaction processing method according to an embodiment of the present disclosure.

FIG. 9A and FIG. 9B are schematic diagrams of interfaces of virtual same-frame implementation of an interaction processing method according to an embodiment of the present disclosure.

FIG. 10 is a diagram of a mapping relationship of an interaction processing method according to an embodiment of the present disclosure.

FIG. 11A and FIG. 11B are schematic diagrams of interfaces of reminding function implementation of an interaction processing method according to an embodiment of the present disclosure.

FIG. 12 is a schematic logic diagram of an interaction processing method according to an embodiment of the present disclosure.

FIG. 13A and FIG. 13B are schematic diagrams of interfaces of commenting function implementation of an interaction processing method according to an embodiment of the present disclosure.

FIG. 14A and FIG. 14B are schematic diagrams of interfaces of chat function implementation of an interaction processing method according to an embodiment of the present disclosure.

FIG. 15 is a schematic logic diagram of an interaction processing method according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure. In the following description, the term “some embodiments” describes subsets of all possible embodiments, but it may be appreciated that “some embodiments” may be the same subset or different subsets of all the possible embodiments, and can be combined with each other without conflict.

The terms, involved in the following description, “first/second/third” are merely intended to distinguish similar objects rather than describing specific orders. It is to be understood that, “first/second/third” is interchangeable in proper circumstances to enable the embodiments of the present disclosure to be implemented in other orders than those illustrated or described herein.

Unless otherwise defined, meanings of all technical and scientific terms used in this specification are the same as those usually understood by a person skilled in the art to which the present disclosure pertains. Terms used herein are merely intended to describe the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

1) Response represents a condition or state upon which performed operations depend, where one or more of the performed operations may be real-time or may have a set delay when the dependent condition or state is satisfied. Without being specifically stated, there is no limitation to the order in which the operations are performed.

2) Multimedia information: The multimedia information involved in the embodiments of the present disclosure is media information in a presentation form of an image, a video, an animation, or the like, and the meaning of the multimedia information is generally considered to be related information obtained by using a storage and retrieval technology, and in particular, digital information in a computer.

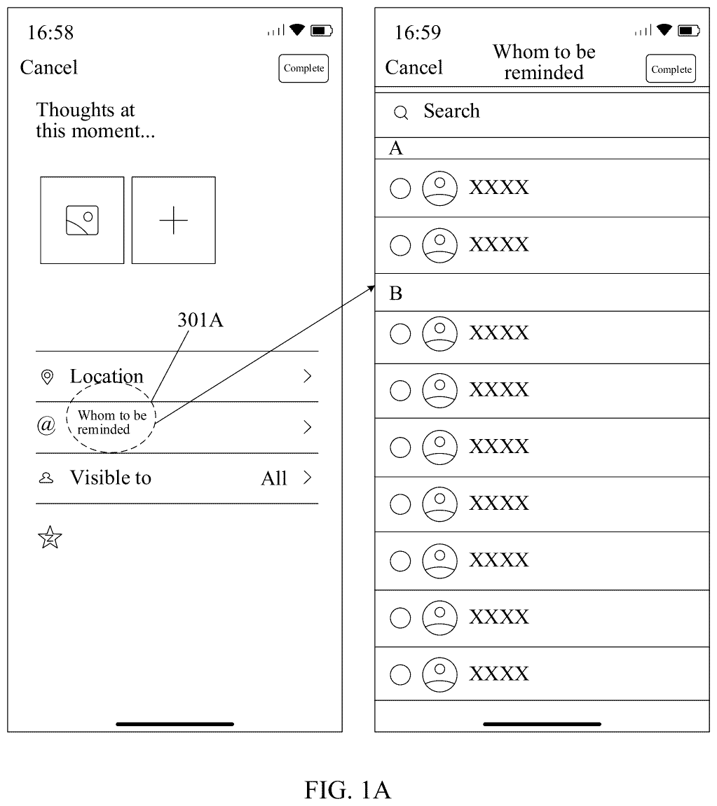

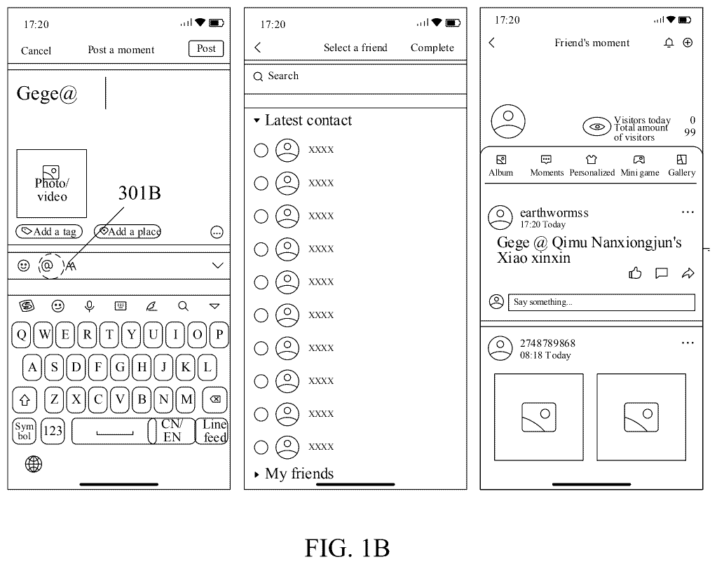

Referring to FIG. 1A and FIG. 1B, in a social information flow APP and an instant messaging APP in the related technology, if a user wants to make content posted by the user be perceived by a related person, the user needs to @the person in the posted information or select, from corresponding options, a friend to be notified. In a stage in which an object posts information, an object list is displayed in response to a trigger operation for a reminder entrance 301A, so that a target object may be selected from the object list to notify the target object to view the information posted by the object, and an object list is displayed in response to a trigger operation for a reminder entrance 301B, so that a target object may be selected from the object list, and a reminder text is added to the posted information to notify the target object to view the information posted by the object. In the related technology, when image content is posted, the user is allowed to add a friend's virtual avatar sticker to the image, to create a virtual same-frame effect.

In the related technology, if a user wants to make content posted by the user be perceived by a related person, the user needs to select a person from a friend list after entering @ in the information, or select a friend from a function such as “Whom to be reminded”. The entire process is relatively redundant and dull, and a final presentation mode is merely @text. In the related technology, a user may need to add virtual avatar stickers of the user and a friend to an image to be transmitted, which is indicative of that the content is related to the friend, but the user still needs to notify the friend of the user by using the foregoing reminding function, resulting in the redundancy of the process.

For the technical problem, the embodiments of the present disclosure provide an interaction processing method and apparatus, an electronic device, a computer-readable storage medium, and a computer program product, which can implement a reminding function by using improvement of a virtual avatar, thereby improving the human-computer interaction efficiency.

An exemplary application of the electronic device provided in the embodiments of the present disclosure is described below. The electronic device provided in the embodiments of the present disclosure may be implemented as various types of user terminals such as a laptop, a tablet computer, a desktop computer, a set-top box, a mobile device (for example, a mobile phone, a portable music player, a personal digital assistant, a dedicated messaging device, or a portable game device), a smart voice interaction device, a smart home appliance, an in-vehicle terminal, and aircraft. The following describes exemplary applications of the electronic device provided in the embodiments of the present disclosure. The electronic device provided in the embodiments of the present disclosure may be a terminal or a server.

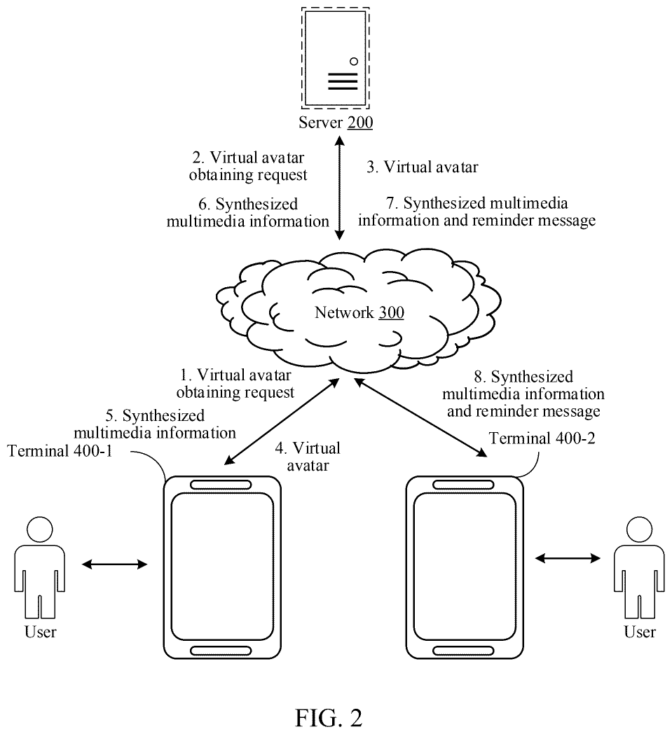

Referring to FIG. 2, FIG. 2 is a schematic structural diagram of an interaction processing system according to an embodiment of the present disclosure. To support a social application, terminals (for example, a terminal 400-1 and a terminal 400-2) are connected to a server 200 via a network 300. The network 300 may be a wide area network, a local area network, or a combination thereof.

In some embodiments, the terminal 400-1 into which a first account logged displays the multimedia information to be edited. In response to a trigger operation for a selection entrance, the terminal 400-1 transmits a virtual avatar obtaining request to the server 200, to obtain a virtual avatar of a second account. The terminal 400-1 displays the virtual avatar of the second account and adds, in response to a virtual avatar selecting operation, the virtual avatar to the multimedia information to be edited, to display the synthesized multimedia information. In response to a transmitting operation for the synthesized multimedia information, the terminal 400-1 transmits the synthesized multimedia information and a reminder message to the server 200, so that the server 200 transmits the multimedia information and the reminder message to the terminal 400-2. In response to that the terminal 400-2 receives a commenting operation, the terminal 400-2 transmits comment information to the server 200, so that the server 200 adds the comment information to a location of the virtual avatar corresponding to the second account in the synthesized multimedia information, and returns the synthesized multimedia information to which the comment information is added to the terminal 400-1 and the terminal 400-2 for displaying.

In some embodiments, the terminal or the server may implement the interaction processing method provided in the embodiments of the present disclosure by running a computer program. For example, the computer program may be an original program or a software module in an operating system; may be a native application (APP), that is, a program that needs to be installed in the operating system to run, such as an instant messaging client, a video conferencing client, and a social networking client; may alternatively be a mini program, which can be run after being simply downloaded to a browser environment; or may alternatively be a mini program that can be embedded in any APP. In summary, the foregoing computer program may be an application program, a module, or a plug-in in any form.

The embodiments of the present disclosure may be implemented by a cloud technology. The cloud technology refers to a hosting technology that unifies a series of resources such as hardware, software, and a network in a wide area network or a local area network to realize a data calculation, storage, processing, and sharing.

The cloud technology is a generic term of a network technology, an information technology, an integration technology, a management platform technology, and an application technology based on application of a cloud computing business model. The resources may form a resource pool and are used on demand, which is flexible and convenient. The cloud computing technology will become an important support. Backend services of a technology network system require a lot of computing and storage resources.

In an example, the server 200 may be an independent physical server, or a server cluster or distributed system composed of a plurality of physical servers, or may be a cloud server for providing basic cloud computing services, such as a cloud service, a cloud database, cloud computing, a cloud function, cloud storage, a network service, cloud communication, a middleware service, a domain name service, a security service, a CDN, big data, and an artificial intelligence platform. The terminal 400-1 may be a smartphone, a tablet computer, a laptop, a desktop computer, a smart speaker, a smartwatch, an in-vehicle terminal, or the like, but is not limited thereto. The terminal 400-1 and the server 200 may be connected directly or indirectly in a wired or wireless communication protocol. This is not limited in the embodiments of the present disclosure.

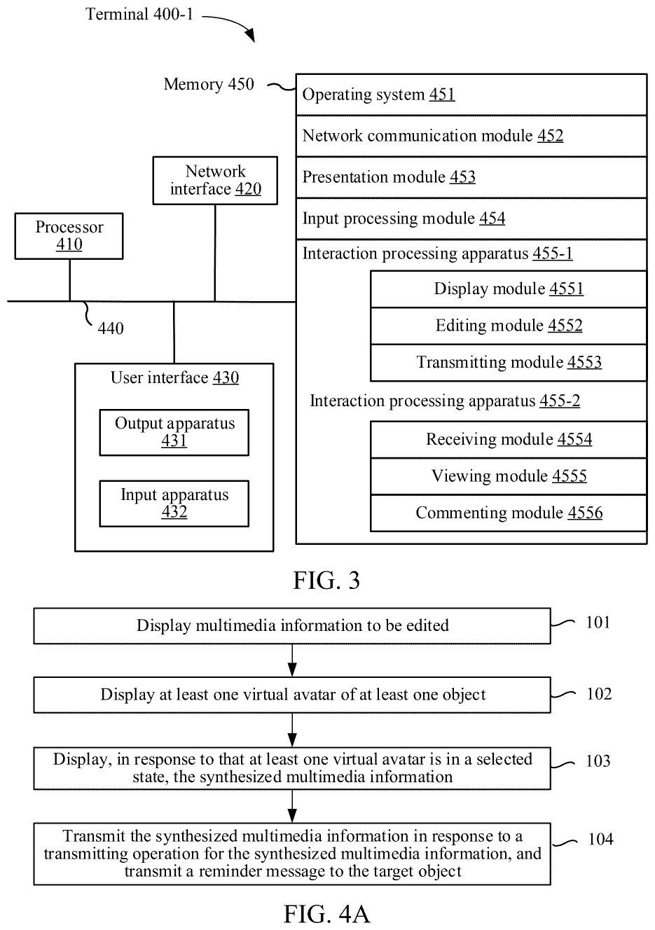

Referring to FIG. 3, FIG. 3 is a schematic structural diagram of an electronic device according to an embodiment of the present disclosure. Terminals shown in FIG. 3 include: at least one processor 410, a memory 450, at least one network interface 420, and a user interface 430. Components in the terminal 400-1 are coupled together via a bus system 440. The bus system 440 is configured to implement connection and communication between the components. In addition to a data bus, the bus system 440 further includes a power supply bus, a control bus, and a state signal bus. However, for ease of clear description, all buses in FIG. 3 are marked as the bus system 440.

The processor 410 may be an integrated circuit chip with signal processing capacity such as a general processor, a digital signal processor (DSP), another programmable logic device, discrete gate or transistor logic device, or discrete hardware assembly, or the like. The general processor may be a microprocessor or any processor, and the like.

The user interface 430 includes one or more output apparatuses 431 that can show the medium content, including one or more speakers and/or one or more visual display screens. The user interface 430 further includes one or more input apparatuses 432, including user interface components that facilitate user input, such as a keyboard, a mouse, a microphone, a touchscreen, a camera, and other input buttons and controls.

The memory 450 may be removable, irremovable, or a combination thereof. The exemplary hardware device includes a solid memory, a hard disk drive, an optical disk drive, and the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read-only memory (ROM), and the volatile memory may be a random-access memory (RAM). The memory 450 described in this embodiment of the present disclosure aims to include any suitable type of memory.

In some embodiments, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a frame layer, a core library layer, and a driver layer, which are configured to implement various basic businesses and process hardware-based tasks.

A network communication module 452 is configured to reach another computing device through one or more (wired or wireless) network interfaces 420. An example of the network interface 420 includes: Bluetooth, wireless fidelity (WiFi), universal serial bus (USB), or the like.

A presentation module 453 is configured to present information through one or more output apparatuses 431 (for example, a display screen or a speaker) associated with a user interface 430 (for example, a user interface for operating a peripheral device and displaying content and information).

An input processing module 454 is configured to detect one or more user inputs or interactions from one of one or more input apparatuses 432 and translate the detected inputs or interactions.

In some embodiments, the interaction processing apparatus provided in embodiments of the present disclosure may be implemented in software. FIG. 3 shows an interaction processing apparatus 455-1 stored in a memory 450, which may be software in the form of a program and a plug-in. The apparatus includes the following software modules: a display module 4551, an editing module 4552, and a transmitting module 4553. FIG. 3 further shows an interaction processing apparatus 455-2 stored in the memory 450. The interaction processing apparatus may be software in a program or plug-in form, and includes the following software modules: a receiving module 4554, a viewing module 4555, and a commenting module 4556. These modules are logical, so that the modules can be arbitrarily combined or further split according to achieved functions. The functions of the modules are to be explained below.

The interaction processing method provided in the embodiments of the present disclosure is described in combination with the exemplary applications and implementations of the terminal provided in the embodiments of the present disclosure.

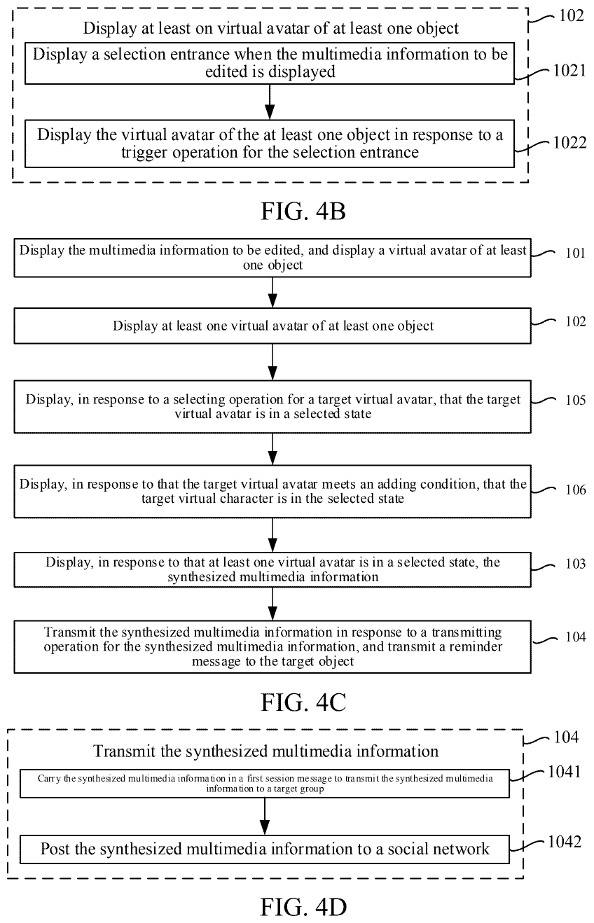

Referring to FIG. 4A, FIG. 4A is a schematic flowchart of an interaction processing method according to an embodiment of the present disclosure. Description is to be provided with reference to operations shown in FIG. 4A.

Operation 101: Display multimedia information to be edited.

Operation 102: Display at least one virtual avatar of at least one object.

In an example, when the multimedia information to be edited is displayed on a human-computer interaction interface, the at least one virtual avatar of the at least one object may also be synchronously displayed on the human-computer interaction interface. Alternatively, after the multimedia information to be edited is displayed on the human-computer interaction interface, the at least one virtual avatar of the at least one object is displayed by using a trigger operation. When the at least one virtual avatar of the at least one object is displayed, the multimedia information to be edited may remain displayed on the human-computer interaction interface. An object, as used herein, may refer to a user account in a social network or instant messaging service.

In an example, the multimedia information to be edited may be an image or a video, and the virtual avatar may be displayed in a form of a virtual avatar sticker of an object (a user).

For example, an image selection entrance exists in both a social moment posting scenario and an instant messaging scenario. In response to the image selection entrance, a plurality of candidate images may be displayed. In response to a selecting operation for a candidate image, the selected candidate image is used as an image to be edited. The image to be edited herein is an image to be posted as a social moment or an image to be carried in a message and transmitted to a group chat by a user. The image to be edited may be edited before the image to be edited is transmitted. The embodiments of the present disclosure provide a method for editing an image to be edited, that is, adding a virtual avatar sticker of an object to the image to be edited. The object herein may refer to the user, or may refer to a user having a social relationship with the user. The social relationship herein is not limited to that two parties have a social relationship with each other. For example, if a user A follows a user B, but the user B does not follow the user A, it may still be considered that the user A and the user B have a social relationship.

In some embodiments, referring to FIG. 4B, in operation 102, displaying at least one virtual avatar of at least one object may be implemented through operation 1021 and operation 1022 shown in FIG. 4B.

Operation 1021: Display a selection entrance when the multimedia information to be edited is displayed.

Operation 1022: Display the at least one virtual avatar of the at least one object in response to a trigger operation for the selection entrance.

According to the embodiments of the present disclosure, the selection entrance may be presented when the multimedia information to be edited is presented, to trigger to display the virtual avatar of the object subsequently, so that the human-computer interaction efficiency can be improved.

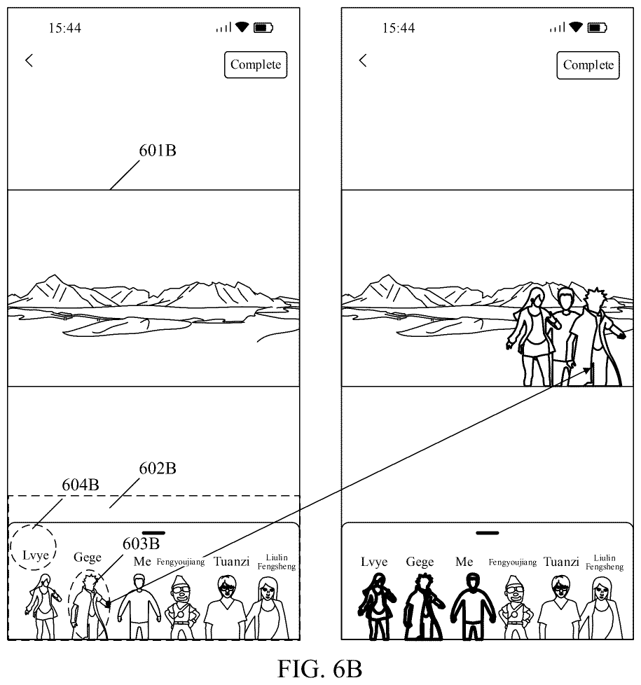

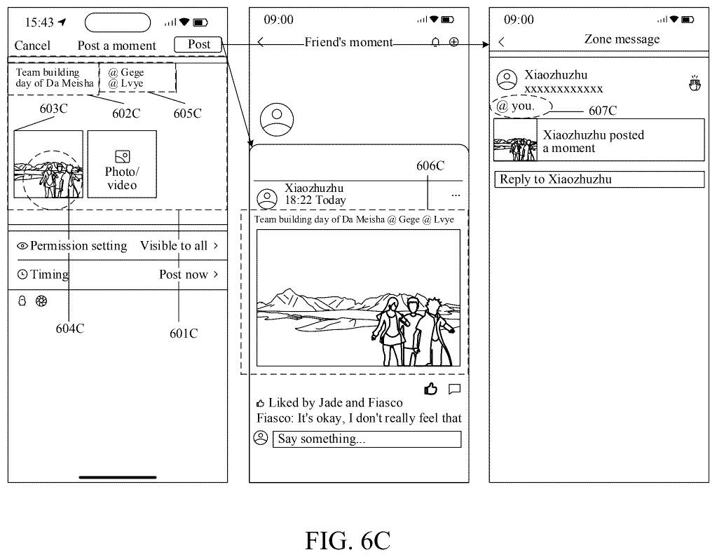

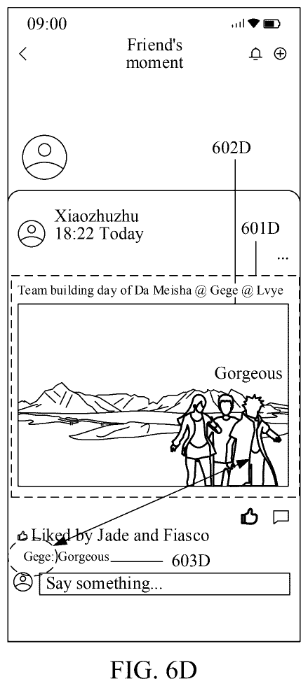

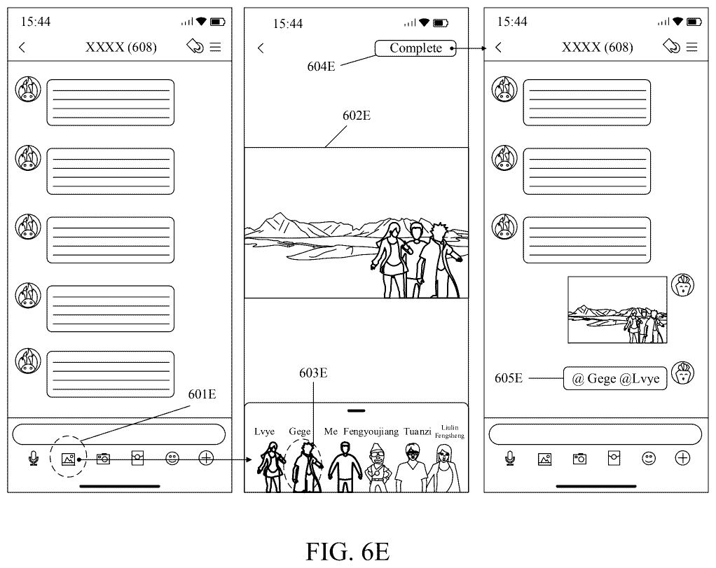

In an example, referring to FIG. 6A, an image selection entrance 601A is displayed on the human-computer interaction interface. In response to a trigger operation for the image selection entrance 601A, candidate images are displayed. In response to a selecting operation for any candidate image, the selected candidate image is used as an image to be edited, and an image to be edited 602A is displayed. In response to a trigger operation for a virtual avatar selection entrance 603A (the selection entrance mentioned in operation 1021), a virtual avatar 604A of the at least one object is displayed, including a virtual avatar of the user and a virtual avatar of another user.

In some embodiments, when the at least one virtual avatar of the at least one object is displayed, an account identifier of an object to which each virtual avatar pertains may further be displayed.

In an example, referring to FIG. 6B, virtual avatars 603B of a plurality of objects and account identifiers 604B of objects to which the virtual avatars pertain are displayed in a virtual avatar candidate area 602B. The account identifiers herein may be nicknames, portraits, and the like of the objects in the social network.

According to the embodiments of the present disclosure, when the virtual avatars are displayed, the account identifiers of the objects to which the virtual avatars pertain are also displayed, so that one-to-one mapping relationships between the objects and the virtual avatars may be presented, to help a user to select a virtual avatar conforming to an object expected by the user, so that mistaken selection of a virtual avatar is avoided and the human-computer interaction efficiency can be improved.

In some embodiments, when a plurality of virtual avatars are provided, the displaying at least one virtual avatar of at least one object in operation 102 may be implemented through the following technical solution: displaying the virtual avatars according to at least one of the following orders: a temporal order starting from a time when a virtual avatar is added the latest to the multimedia information to be edited; a descending order of frequencies at which the virtual avatars are added to the multimedia information to be edited; a descending order of frequencies of interactions between objects corresponding to the virtual avatars and an editing object, the editing object being an object triggering the transmitting operation; or a temporal order starting from a time when an object corresponding to a virtual avatar interacts the latest with an editing object. According to the embodiments of the present disclosure, a virtual avatar may be recommended by using a displaying mode, so that the human-computer interaction efficiency can be improved.

For example, the virtual avatars may be displayed in an order. For example, a virtual avatar lately added to the multimedia information to be edited is priorly presented. For example, a virtual avatar frequently added to the multimedia information to be edited is priorly presented. For example, a virtual avatar of another user who frequently interacts with the user (the editing object) is priorly presented. For example, a virtual avatar of another user who lately interacts with the user is priorly presented.

In some embodiments, the displaying at least one virtual avatar of at least one object in operation 102 may be implemented through the following technical solution: when the multimedia information to be edited includes any object, performing at least one of the following processing: displaying a virtual avatar of the any object; and displaying a virtual avatar of another object that has a social relationship with the any object. According to the embodiments of the present disclosure, a virtual avatar related to content of the multimedia information may be displayed, so that the visual effect can be enriched and the interest relating to editing can be improved.

In an example, the multimedia information to be edited may be an image or a video, and image recognition processing may be performed on the multimedia information by using an image processing technique. When the multimedia information to be edited is an image A and it is recognized that the image A includes an object A, a virtual avatar of at least one of the object A and a virtual avatar of an object B having a social relationship with the object A may be displayed. When the multimedia information to be edited is a video C, key frames of the video C are extracted, and image recognition processing is performed on each key frame, to obtain an object included in each key frame. For example, for a key frame D, objects D1 and D2 may be recognized, and for a key frame E, objects E1 and E2 may be recognized. In this case, a virtual avatar of at least one of the object D1, the object D2, and an object D3 having a social relationship with the object D1 or the object D2 may be displayed for the key frame D, and a virtual avatar of at least one of the object E1, the object E2, and an object E3 having a social relationship with the object E1 or the object E2 may be displayed for the key frame E.

In some embodiments, before the at least one virtual avatar of the at least one object is displayed, an object set is obtained. The object set includes an editing object and an object having a social relationship with the editing object, the editing object is an object triggering the transmitting operation, and each object in the object set has a corresponding virtual avatar. The virtual avatar of each object in the object set is obtained based on the object set. Specifically, the object set having virtual avatars is obtained from a server. The object set includes an editing object and an object having a social relationship with the editing object, and the editing object is an object triggering the transmitting operation. The virtual avatar of each object in the object set is obtained from the server based on the object set. According to the embodiments of the present disclosure, the object set having the virtual avatars may be first selected, and then the virtual avatar corresponding to the object in the object set is obtained based on the object set, so that the efficiency of obtaining the virtual avatar is improved, and obtaining of an object associated with the virtual avatar after directly obtaining the virtual avatar is avoided.

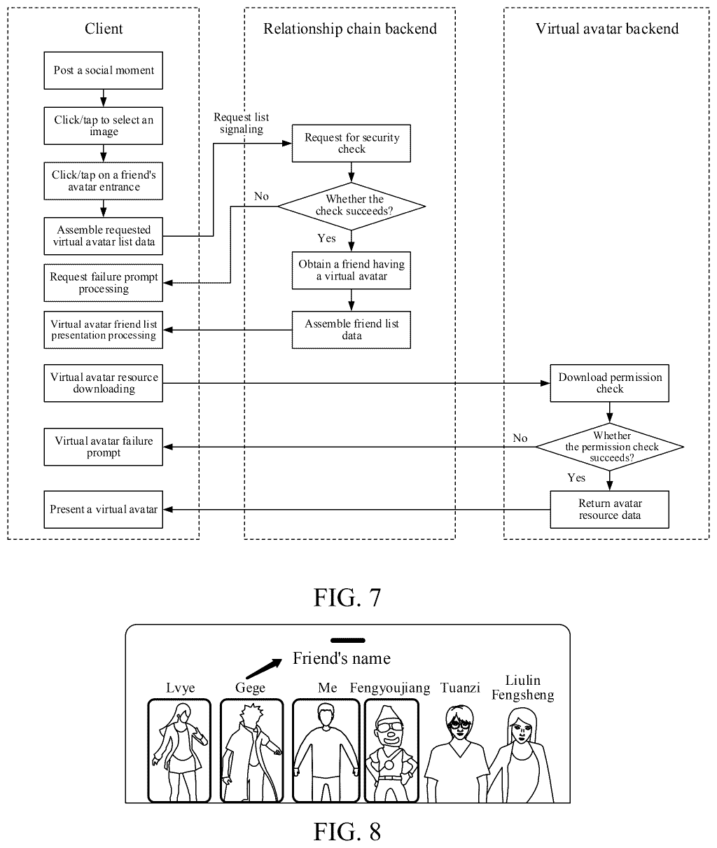

In an example, referring to FIG. 7, in an application scenario of posting a social moment to a social network, a friend's virtual avatar entrance is added to an image editing interface, for a user to select a friend's virtual avatar when editing an image. After the friend's virtual avatar is selected, the friend's virtual avatar may be quickly attached to the image. Interactions between friends may be implemented by using the virtual avatars. A client performs logic interaction with a relationship chain backend and a virtual avatar backend, to provide the user with a capability of adding a friend's virtual avatar to an image. After the user selects a friend's avatar, the client needs to first obtain a friend list having virtual avatars from the relationship chain backend, then request for a virtual avatar resource of the friend from the virtual avatar backend by using a pulled chain list, and present a downloaded virtual avatar to a corresponding list.

Operation 103: Display, in response to that one of the at least one virtual avatar is in a selected state, the synthesized multimedia information.

In an example, the synthesized multimedia information is obtained by adding the virtual avatar in the selected state to the multimedia information to be edited.

In some embodiments, referring to FIG. 4C, before performing operation 103, operation 105 or operation 106 shown in FIG. 4C may further be performed.

Operation 105: Display, in response to a selecting operation for the at least one virtual avatar, that the at least one virtual avatar is in the selected state.

In an example, referring to FIG. 6B, in response to the selecting operation for any virtual avatar, the selected virtual avatar in the virtual avatar candidate area 602B is displayed in the selected state, and the virtual avatar 603B is added to the image 601B (the multimedia information to be edited).

Operation 106: Display, in response to that the at least one virtual avatar meets an adding condition, that the at least one virtual avatar is in the selected state.

In the embodiments of the present disclosure, the virtual avatar may be selected in an automatic selecting mode, and the automatically selected virtual avatar is displayed in the selected state. A virtual avatar meeting an adding condition may be automatically selected and displayed in the selected state.

In some embodiments, the adding condition includes at least one of the following: the virtual avatar being a virtual avatar lately added to the multimedia information to be edited; the virtual avatar being a virtual avatar having a highest frequency of being added to the multimedia information to be edited; the object corresponding to the virtual avatar being an object having a highest frequency of interaction with the editing object, and the editing object being the object triggering the transmitting operation; or the object corresponding to the virtual avatar being an object lately interacting with the editing object. According to the embodiments of the present disclosure, a virtual avatar is automatically selected, so that a selecting process by a user is avoided and the human-computer interaction efficiency is improved.

For example, for an editing object A, the editing object A herein is an object that is about to transmit or post multimedia information to be edited. A virtual avatar lately added by the editing object A may be used as an automatically selected virtual avatar, a virtual avatar most frequently added by the editing object A may be used as an automatically selected virtual avatar, a virtual avatar of an object B with which the editing object A most frequently interacts may be used as an automatically selected virtual avatar, and a virtual avatar of an object B with which the editing object A lately interacts may be used as an automatically selected virtual avatar.

Operation 104: Transmit the synthesized multimedia information in response to a transmitting operation for the synthesized multimedia information, and transmit a reminder message to the target object.

In an example, the target object is one of the at least one object whose virtual avatar is comprised in the synthesized multimedia information, and the reminder message is configured for reminding the target object to view the synthesized multimedia information. Here, there are two application scenarios of transmitting the synthesized multimedia information. The synthesized multimedia information may be transmitted to a social network, or the synthesized multimedia information may be transmitted to a group chat.

In some embodiments, referring to FIG. 4D, the displaying the synthesized multimedia information in operation 104 may be implemented through operation 1041 and operation 1042 shown in FIG. 4D.

Operation 1041: Carry the synthesized multimedia information in a first session message to transmit the synthesized multimedia information to a target group, the target group including the at least one target object

In some embodiments, after the carrying the synthesized multimedia information in a first session message to transmit the synthesized multimedia information to a target group, any one of the following processing is performed: displaying, on a session interface of the target group, the first session message carrying the synthesized multimedia information; or displaying, on a session interface of the target group, the first session message carrying the synthesized multimedia information, and displaying, on the session interface of the target group, a second session message, the second session message including an account identifier of the target object and a reminder symbol for each account identifier. According to the embodiments of the present disclosure, the text reminder may be displayed or hidden, so that the display resource utilization rate is increased.

In an example, the embodiments of the present disclosure may alternatively be applied to an instant messaging APP. An image is selected to be transmitted in an instant chat window, a friend's virtual avatar is added to the image, and after the image is transmitted, a message for reminding the corresponding friend is automatically generated. Referring to FIG. 6E, an image selection entrance 601E is displayed on the session interface. In response to a trigger operation for the image selection entrance 601E, candidate images are displayed. In response to a selecting operation for any candidate image, the selected candidate image is used as an image to be edited, and an image to be edited 602E is displayed. In response to a trigger operation for a virtual avatar selection entrance, virtual avatars 603E of a plurality of friends are displayed, and a virtual avatar 603E in a selected state is added to the image to be edited 602E. In response to a trigger operation for a complete control 604E, a synthesized image (the synthesized multimedia information in the first session message) including the virtual avatars is displayed on the session interface, and a message (the second session message) including a reminder text 605E is displayed on the session interface. The reminder text herein includes an account identifier and a reminder symbol. For example, the reminder text “@Wenwen” includes an account identifier “Wenwen” and a reminder symbol “@”.

In some embodiments, after the carrying the synthesized multimedia information in a first session message to transmit the synthesized multimedia information to a target group, in response to a commenting operation by the target object on the synthesized multimedia information, comment information is displayed at a location corresponding to a target virtual avatar in the synthesized multimedia information included in the first session message; or in response to a commenting operation by the target object on the synthesized multimedia information, a third session message transmitted by the target object is displayed, the third session message including the synthesized multimedia information, and comment information being displayed at a location corresponding to a target virtual avatar in the synthesized multimedia information of the third session message. The target virtual avatar is a virtual avatar in the synthesized multimedia information and corresponding to the target object, and the comment information is information inputted by using the commenting operation. According to the embodiments of the present disclosure, the comment information may be updated and displayed directly in the first session message, so that the display resource utilization rate can be improved. Alternatively, the comment information may be displayed in the another third session message, so that commented information and sub-messages of the comment information can be displayed, and the display effect is optimized.

In an example, the session interface may display the first session message. The first session message is a message transmitted by the editing object and carrying the synthesized multimedia information. The synthesized multimedia information includes a virtual avatar of a target object A. The target object A triggers a commenting operation for the synthesized multimedia information. The commenting operation herein may be an operation of pressing-and-holding the first session message and clicking/tapping on a reply control. Comment information is inputted by using the commenting operation. The inputted comment information may be directly displayed at the virtual avatar of the target object A that is of the synthesized multimedia information of the first session message. That is, the first session message is a message that can be updated. Alternatively, the target object may directly transmit a third session message. The third session message also carries the synthesized multimedia information, and the comment information is displayed at a location of the corresponding virtual avatar on the synthesized multimedia information of the third session message.

Operation 1042: Post the synthesized multimedia information to a social network, the at least one target object having a social account of the social network.

In some embodiments, when the synthesized multimedia information is transmitted to the social network, before the responding to the transmitting operation for the synthesized multimedia information, a social moment editing interface is displayed in response to a completed editing operation for the synthesized multimedia information. The synthesized multimedia information to be transmitted is displayed in a multimedia area of the social moment editing interface. In response to a trigger operation for a transmitting control, the trigger operation is identified as a transmitting operation for the synthesized multimedia information. When displaying, in a multimedia area of the social moment editing interface, synthesized multimedia information to be transmitted, an account identifier of the target object and a reminder symbol for each account identifier are displayed in a text area of the social moment editing interface. According to the embodiments of the present disclosure, when the synthesized multimedia information to be transmitted is displayed, the account identifier of the target object and the reminder symbol for each account identifier are simultaneously displayed, so that a reminder for the virtual avatar is visually presented in a text mode, and the display resource utilization rate can be improved.

In an example, after the user adds a friend's virtual avatar to the image, a corresponding friend is automatically @ at a text location of a social moment to be posted by the user, that is, manual input is not needed. After the social moment including the image is posted, the corresponding friend is reminded to view. The friend may receive a message notification, and the social moment may be viewed by clicking/tapping on the message. Referring to FIG. 6C, a text 602C edited by the user is displayed in an editing area 601C (the social moment editing interface). An image 603C (the synthesized multimedia information to be transmitted) includes a virtual avatar 604C. Therefore, after the text 602C, a reminder text 605C for a friend to which the virtual avatar 604C pertains may be automatically displayed. Regardless of whether the reminder text is displayed, the reminder message may be transmitted to the friend to which the virtual avatar 604C pertains. The reminder text herein includes an account identifier and a reminder symbol. For example, the reminder text “@Wenwen” includes an account identifier “Wenwen” and a reminder symbol “@”.

In some embodiments, when the synthesized multimedia information is transmitted to the social network, in response to a commenting operation by the target object on the synthesized multimedia information, comment information for the synthesized multimedia information is displayed at a location of the virtual avatar corresponding to the target object on the synthesized multimedia information. According to the embodiments of the present disclosure, the comment information, the object, and the virtual avatar may be presented in an associated manner, so that an association relationship may be reflected when the comment information is presented, and the display resource utilization rate is improved.

In an example, when the reminded user comments on the social moment, a latest message of the comment by the user is displayed at a corresponding virtual avatar on the image (the synthesized multimedia information). Referring to FIG. 6D, a social moment 601D is displayed in the social network. The social moment 601D includes an image 602D. Comment information 603D posted by a friend A may be displayed in a comment area, or may alternatively be displayed at a virtual avatar corresponding to the friend A on the image 602D.

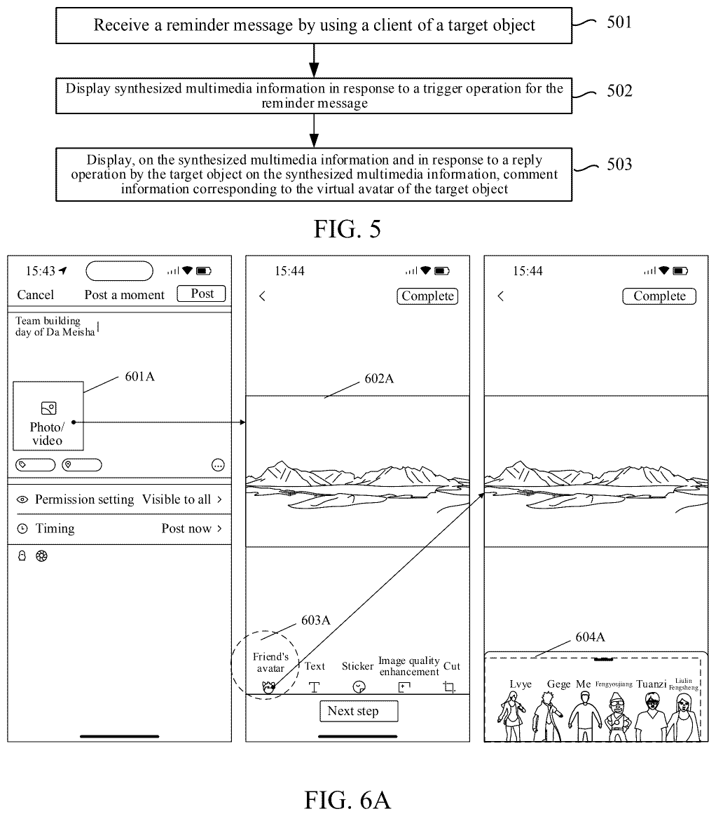

In some embodiments, referring to FIG. 5, FIG. 5 is a schematic flowchart of an interaction processing method according to an embodiment of the present disclosure. Descriptions are made with reference to operations shown in FIG. 5.

Operation 501: Receive a reminder message by using a client of a target object.

Operation 502: Display synthesized multimedia information in response to a trigger operation for the reminder message, the synthesized multimedia information including a virtual avatar of the target object.

Operation 503: Display, on the synthesized multimedia information and in response to a commenting operation by the target object on the synthesized multimedia information, comment information corresponding to the virtual avatar of the target object.

For a specific implementation of operation 503, the specific implementation of comment interaction may be referred to in the foregoing embodiments.

In some embodiments, when the synthesized multimedia information is transmitted to the social network, in response to a commenting operation by the target object on the synthesized multimedia information, comment information for the synthesized multimedia information is displayed at a location of the virtual avatar corresponding to the target object on the synthesized multimedia information.

In some embodiments, when the target object receives the reminder message by using the target group, the synthesized multimedia information is carried in the first session message received in the target group. In response to a commenting operation by the target object on the synthesized multimedia information, comment information is displayed at a location corresponding to a target virtual avatar in the synthesized multimedia information included in the first session message. Alternatively, in response to a commenting operation by the target object on the synthesized multimedia information, a second session message transmitted by the target object is displayed, the second session message including the synthesized multimedia information, and comment information being displayed at a location corresponding to a target virtual avatar in the synthesized multimedia information of the second session message. The target virtual avatar is a virtual avatar in the synthesized multimedia information and corresponding to the target object, and the comment information is information inputted by using the commenting operation.

According to the embodiments of the present disclosure, multimedia information to be edited and a virtual avatar of at least one object are displayed, synthesized multimedia information obtained by adding a virtual avatar in a selected state to the multimedia information to be edited is displayed in response to that the at least one virtual avatar is in the selected state, which is equivalent to achieving a visual effect of being in a same frame with the virtual avatar of the object by editing the multimedia information, and subsequently a reminder message is also transmitted to the object to which the virtual avatar included in the synthesized multimedia information pertains during transmitting of the synthesized multimedia information, so as to remind the target object to view the synthesized multimedia information. That is, a reminding operation can be replaced by adding the virtual avatar. Therefore, the human-computer interaction efficiency is effectively improved while the visual effects are enriched.

The following describes exemplary application of this embodiment of the present disclosure in an actual application scenario.

In some embodiments, a first terminal into which a first account logged displays the multimedia information to be edited. In response to a trigger operation for a selection entrance, the first terminal transmits a virtual avatar obtaining request to a server, to obtain a virtual avatar of a second account. The first terminal displays the virtual avatar of the second account and adds, in response to a virtual avatar selecting operation, the virtual avatar to the multimedia information to be edited, to display the synthesized multimedia information. In response to a transmitting operation for the synthesized multimedia information, the first terminal transmits the synthesized multimedia information and a reminder message to the server, so that the server transmits the multimedia information and the reminder message to a second terminal. In response to that the second terminal receives a commenting operation, the second terminal transmits comment information to the server, so that the server adds the comment information to a location of the virtual avatar corresponding to the second account in the synthesized multimedia information, and returns the synthesized multimedia information to which the comment information is added to the first terminal and the second terminal for displaying.

An embodiment of the present disclosure provides a method for reminding a friend by using a virtual avatar sticker. When posting an image, a user may add a friend's virtual avatar sticker to the image, to decorate the image, to achieve the effect of being in a same frame with the friend. When such an image having a virtual avatar sticker is posted, the friend of the corresponding virtual avatar sticker is automatically reminded, and the friend may receive a message reminder for viewing the image. In addition, a comment of the corresponding friend in this piece of content is also displayed at the virtual avatar of the image. In the process in which the user edits the image, the friend is directly reminded without an additional operation. Such the method for reminding a friend is more natural and interesting, and the embodiments of the present disclosure may be applied to an information flow APP and an instant messaging APP.

In some embodiments, when a user posts an image in a social network, a friend avatar entrance may be opened in an image editor, to present virtual avatars of all friends. Referring to FIG. 6A, an image selection entrance 601A is displayed on the human-computer interaction interface. In response to a trigger operation for the image selection entrance 601A, candidate images are displayed. In response to a selecting operation for any candidate image, the selected candidate image is used as an image to be edited, and an image to be edited 602A is displayed. In response to a trigger operation for a virtual avatar selection entrance 603A, virtual avatars 604A of a plurality of friends are displayed.

In some embodiments, after the user clicks/taps on the friend's avatar, the friend's avatar may be added to the image, to achieve a virtual same-frame effect. Referring to FIG. 6B, an image 601B is displayed on the human-computer interaction interface, and virtual avatars 603B of a plurality of friends and account identifiers 604B of objects to which the virtual avatars pertain are displayed in a virtual avatar candidate area 602B. In response to a selecting operation for any virtual avatar, the virtual avatar 603B is added to the image 601B, and the selected virtual avatar in the virtual avatar candidate area 602B is displayed in a selected state.

In some embodiments, after the user adds a friend's virtual avatar to the image, a corresponding friend is automatically @ at a text location of a social moment to be posted by the user, that is, manual input is not needed. After the social moment including the image is posted, the corresponding friend is reminded to view. The friend may receive a message notification, and the social moment may be viewed by clicking/tapping on the message. Referring to FIG. 6C, a text 602C edited by a user is displayed in an editing area 601C. An image 603C includes a virtual avatar 604C, and therefore a reminder text 605C for a friend to which the virtual avatar 604C pertains is automatically displayed after the text 602C. A social moment includes the reminder text, and therefore a reminder message may be transmitted to the friend. After the social moment is posted, the social moment 606C is displayed on a home page of a social network, and a reminder message 607C is displayed on a client of the friend.

In some embodiments, when the reminded user comments on the social moment, a latest message of the comment by the user may be displayed on the corresponding virtual avatar on the image. Referring to FIG. 6D, a social moment 601D is displayed in the social network. The social moment 601D includes an image 602D. Comment information 603D posted by a friend A may be displayed in a comment area, or may alternatively be displayed at a virtual avatar corresponding to the friend A on the image 602D.

In some embodiments, the embodiments of the present disclosure may alternatively be applied to an instant messaging APP. An image is selected to be transmitted in an instant chat window, a friend's virtual avatar is added to the image, and after the image is transmitted, a message for reminding the corresponding friend is automatically generated. Referring to FIG. 6E, an image selection entrance 601E is displayed on the session interface. In response to a trigger operation for the image selection entrance 601E, candidate images are displayed. In response to a selecting operation for any candidate image, the selected candidate image is used as an image to be edited, and an image to be edited 602E is displayed. In response to a trigger operation for a virtual avatar selection entrance, virtual avatars 603E of a plurality of friends are displayed, and a virtual avatar 603E in a selected state is added to the image to be edited 602E. In response to a trigger operation for a complete control 604E, a synthesized image including the virtual avatars is displayed on the session interface, and a message including a reminder text 605E is displayed on the session interface.

In some embodiments, referring to FIG. 7, in an application scenario of posting a social moment to a social network, a friend's virtual avatar entrance is added to an image editing interface, for a user to select a friend's virtual avatar when editing an image. After the friend's virtual avatar is selected, the friend's virtual avatar may be quickly attached to the image. Interactions between friends may be implemented by using the virtual avatars. A client performs logic interaction with a relationship chain backend and a virtual avatar backend, to provide the user with a capability of adding a friend's virtual avatar to an image. After the user selects a friend's avatar, the client needs to first obtain a friend list having virtual avatars from the relationship chain backend, then request for a virtual avatar resource of the friend from the virtual avatar backend by using a pulled chain list, and present a downloaded virtual avatar to a corresponding list. Specifically, the virtual avatar backend may perform download permission check, and whether a token carried in the user request is valid needs to be verified. The token carried in the user request is also a token generated by the relationship chain backend, to facilitate check. The token carried in the user request is a certificate of a valid identity of the user. Whether a user has a virtual avatar is marked in the relationship chain, and related data of the virtual avatar is maintained by the virtual avatar backend. In the embodiments of the present disclosure, the related data of the virtual avatar is stored to the virtual avatar backend. Referring to FIG. 8, each virtual avatar is an avatar set by a friend of a user, and a name of the friend is correspondingly displayed on the virtual avatar, so that the user can identify the avatar of each friend.

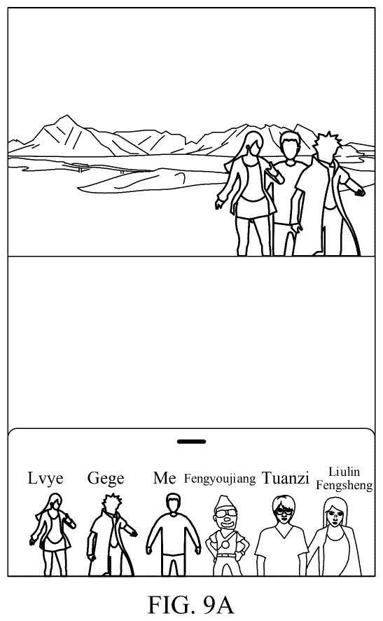

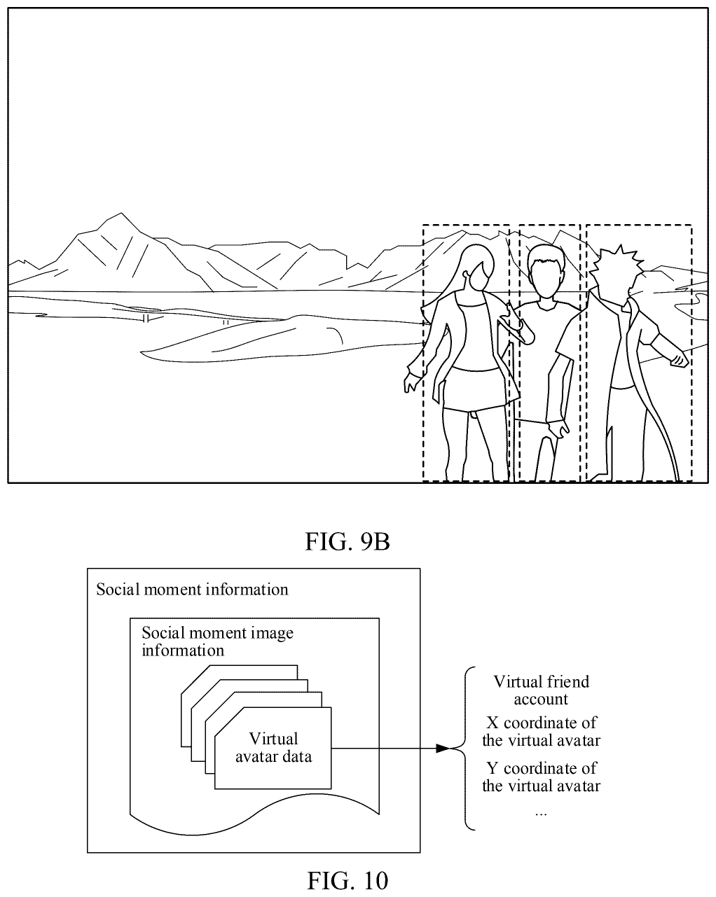

In some embodiments, the following describes virtual same-frame implementation. Referring to FIG. 9A, a user may add an image when posting a social moment, perform interactive editing in the image, and may combine a friend's virtual avatar with the image. Referring to FIG. 9B, a user may select a friend's virtual avatar from a friend's virtual avatar list to merge with the image. In an image editing interface, the image is used as a background, and selected friend's virtual avatars are displayed on the image side by side. Each virtual avatar previewed in an editing stage is a virtual avatar image resource, and the virtual avatar is an independent individual for the user to preview an editing effect. Referring to FIG. 10, only after the user completes editing and posts the image, the corresponding image and the selected virtual avatar image are merged into one image for posting. In addition, when the image is posted, related information of the image may carry coordinate information of each virtual avatar, to facilitate subsequently attaching of a comment on a corresponding virtual avatar when a corresponding friend makes a comment. One image corresponds to a plurality of pieces of virtual avatar information, including social account information and coordinate information of a friend corresponding to the virtual avatar.

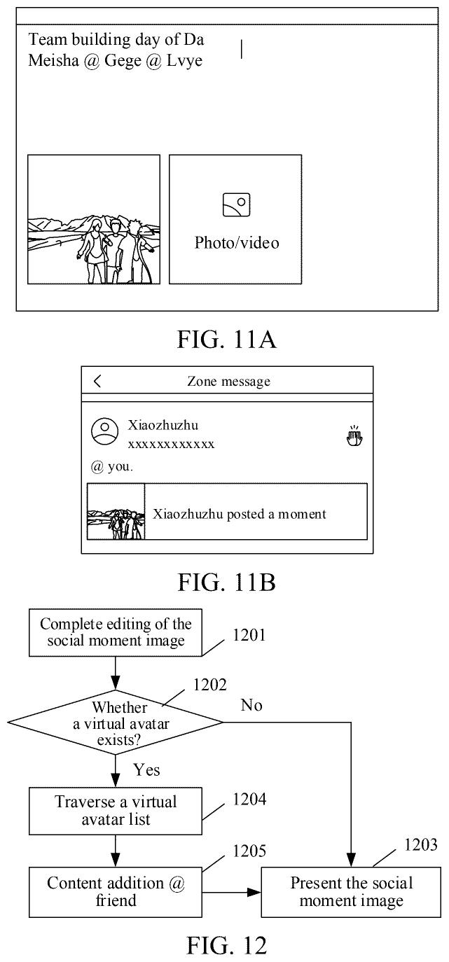

In some embodiments, the following describes technical implementation that a reminding function is provided after a virtual avatar is added to an image. Referring to FIG. 11A, after a user edits an image, to increase interaction between users when the user posts the image, a friend whose virtual avatar is added is notified, so that the friend whose virtual avatar is added is notified at a first time, and the friend is reminded to view the posted image. Referring to FIG. 11B, after the user completes editing the image, a reminder text is automatically added to a social moment. The reminder text includes information about the friend whose virtual avatar is added. The posted image may be conveyed to the friend at the first time by using a reminder capability of the reminder text (@someone). The friend may further view the image at the first time by using a reminder message (a zone message). By using the reminder capability of the reminder text (@someone), the zone message is used as a reminder message to convey the posted image. The friend may click/tap on the zone message to view the posted image. Referring to FIG. 12, in operation 1201, the edited image is displayed. In operation 1202, whether a virtual avatar exists is determined. When no virtual avatars exist, operation 1203 is performed. In operation 1203, the image is displayed. When the virtual avatar exists, operation 1204 is performed. In operation 1204, a virtual avatar list is traversed. In operation 1205, a reminder text is added to a social moment. A reminder text “@someone” of a corresponding friend is added to content of the social moment. A friend source is a friend corresponding to a virtual avatar selected during image editing. Addition to the content of the social moment is performed when the image is edited and returned back to an interface to be transmitted. A client may automatically add the reminder text to the content of the social moment according to the virtual avatar selected by the user, so as to quickly add a friend to be reminded and notify the friend by transmitting the reminder text.

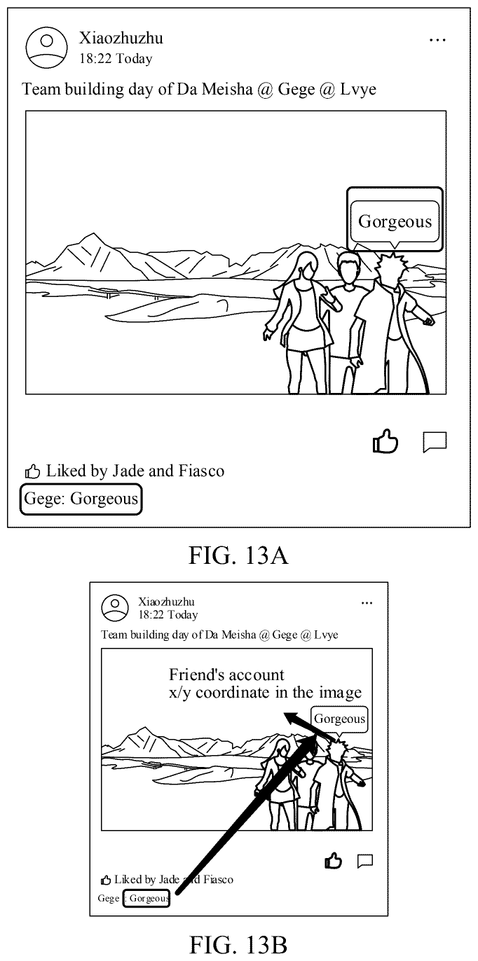

In some embodiments, the following describes functional implementation of attaching friend comment information to an image. Referring to FIG. 13A, to highlight an interaction with a friend of a virtual avatar in a social moment, when the corresponding friend of the virtual avatar added to the image makes a comment, comment information is attached to the image, to facilitate perceiving of interaction information with the friend at a first time. Referring to FIG. 13B, when the image is posted, the edited virtual avatar of the friend is merged with the image to be edited to form an image. Information about the friend of the virtual avatar is attached to the synthesized image, including an account of the corresponding friend of the virtual avatar. In addition, coordinates of the virtual avatar in the image may further exist. The coordinates are used to attach, when the corresponding friend makes a comment, the comment to a moment image. When the social moment is presented, if image information exists, the image is presented as a background, and friend's comment information is superimposed on the background of the image. A location of the comment information in an image presentation area is determined according to the virtual avatar information. If an author who makes a comment has a corresponding virtual avatar added to the image, the comment information needs to be superimposed on the image.

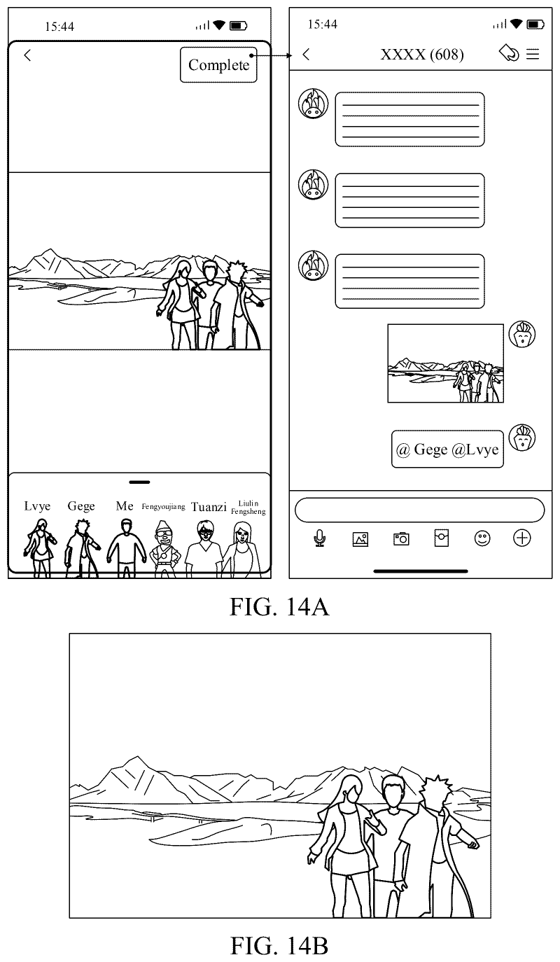

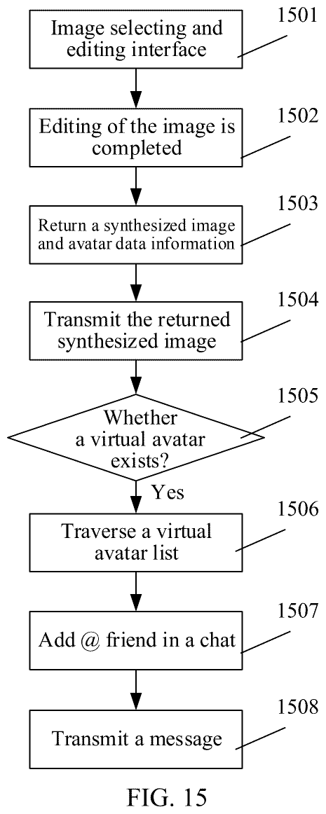

In some embodiments, the following describes a solution of supporting a reminding function of an image sticker in a chat message transmitting scenario. Referring to FIG. 14A, a capability of adding a friend's virtual avatar to an image is not limited to posting of a social moment in a social network, and is further configured for transmitting an image message to a group chat. An image editing interface also appears after an image is selected during transmitting. A reminding function implemented by adding a friend's virtual avatar to an image is a common component, which can be directly reused by various services. Referring to FIG. 14B, for the common component, after calling of a service is completed, the synthesized image is returned to the service. In addition, selected friend's virtual avatar list information is also returned, including a friend account and coordinate information of the virtual avatar in the image. Similar to an image in a social moment, for a logic processing process of transmitting a message, refer to FIG. 15. In operation 1501, an image selection interface is displayed. In operation 1502, image editing processing is performed. In operation 1503, image information and avatar data information are obtained. In operation 1504, a synthesized image is transmitted. In operation 1505, whether a virtual avatar exists is determined. When the virtual avatar exists, operation 1506 is performed. In operation 1506, a virtual avatar list is traversed. In operation 1507, a reminder text for a friend is added during chatting. In operation 1508, a message including a reminder text is transmitted.

The embodiments of the present disclosure are not limited to adding a virtual avatar to an image when posting a social moment. Editing a friend's virtual avatar that can be selected during selection of an image, to implement a reminding function for the friend is encapsulated into a common component. Demands of various services may be implemented by using the common component. The component may provide an image synthesized by a service party and related information of the friend's virtual avatar.

An embodiment of the present disclosure provides a function of reminding a friend by using a virtual avatar sticker of the friend. When posting image content, a user may add a friend's virtual avatar sticker of the user to an image, to decorate the image, to achieve the effect of being in a same frame with the friend. In the embodiment of the present disclosure, when such the content image having a virtual avatar sticker is posted, a friend corresponding to a corresponding virtual avatar attached on the image is automatically reminded, and the friend receives a message reminder to view the content. In addition, a comment of the corresponding friend in this piece of content is also displayed at the virtual avatar of the image. In the process in which the user edits image, the peer party is directly reminded without an additional operation. This method of reminding a friend to view is more natural and interesting. The embodiments of the present disclosure may be applied to an information flow APP and an instant messaging APP, to reduce the operation costs of reminding a friend to view content by a user, and improve the interaction rate between friends.

In this embodiment of the present disclosure, related data such as user information is involved. When the embodiments of the present disclosure are applied to specific products or technologies, user permission or consent needs to be obtained, and collection, use, and processing of relevant data need to comply with relevant laws, regulations, and standards of relevant countries and regions.

During implementation of the related data obtaining technical solution in the present disclosure, when the foregoing embodiments of the present disclosure are applied to a specific product or technology, a related data collection, use, and processing process is to comply with requirements of national laws and regulations, satisfy legal, justified, and necessary principles, and do not relate to obtaining a data type prohibited or limited by the laws and regulations, so as not to hinder normal running of the target website.

An exemplary structure of the interaction processing apparatus 455-1 provided in the embodiments of the present disclosure implemented as a software module is further described below. In some embodiments, as shown in FIG. 2, software modules in the interaction processing apparatus 455-1 stored in the memory 450 may include: a display module 4551, configured to display multimedia information to be edited; and display at least one virtual avatar of at least one object; and an editing module 4552, configured to display synthesized multimedia information in response to that one of the at least one virtual avatar is in a selected state, the synthesized multimedia information being obtained by adding the virtual avatar in the selected state to the multimedia information to be edited; and a transmitting module 4553, configured to transmit the synthesized multimedia information, and transmit a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

In some embodiments, the display module 4551 is further configured to: display a selection entrance when the multimedia information to be edited is displayed; display the at least one virtual avatar of the at least one object in response to a trigger operation for the selection entrance; and display an account identifier of an object to which each virtual avatar pertains.

In some embodiments, the display module 4551 is further configured to: display the virtual avatars according to at least one of the following orders: a temporal order starting from a time when a virtual avatar is lately added to the multimedia information to be edited; a descending order of frequencies at which the virtual avatars are added to the multimedia information to be edited; a descending order of frequencies of interactions between objects corresponding to the virtual avatars and an editing object, the editing object being an object triggering the transmitting operation; or a temporal order starting from a time when an object corresponding to a virtual avatar lately interacts with an editing object.

In some embodiments, the display module 4551 is further configured to: when the multimedia information to be edited includes any object, perform at least one of the following processing: displaying a virtual avatar of the any object; and displaying a virtual avatar of another object that has a social relationship with the any object.

In some embodiments, the display module 4551 is further configured to: before the at least one virtual avatar of the at least one object is displayed, obtain an object set; the object set including an editing object and an object having a social relationship with the editing object, the editing object being an object triggering the transmitting operation, and each object in the object set having a corresponding virtual avatar; and obtain the virtual avatar of each object in the object set based on the object set.

In some embodiments, before the responding to that the at least one virtual avatar is in a selected state, the editing module 4552 is further configured to: display, in response to a selecting operation for the at least one virtual avatar, that the at least one virtual avatar is in the selected state; or display, in response to that the at least one virtual avatar meets an adding condition, that the at least one virtual avatar is in the selected state.

In some embodiments, the adding condition includes at least one of the following: the virtual avatar being a virtual avatar lately added to the multimedia information to be edited; the virtual avatar being a virtual avatar having a highest frequency of being added to the multimedia information to be edited; the object corresponding to the virtual avatar being an object having a highest frequency of interaction with the editing object, and the editing object being the object triggering the transmitting operation; or the object corresponding to the virtual avatar being an object lately interacting with the editing object.

In some embodiments, the transmitting module 4553 is configured to: carry the synthesized multimedia information in a first session message to transmit the synthesized multimedia information to a target group, the target group including the at least one target object; or post the synthesized multimedia information to a social network, the at least one target object having a social account of the social network.

In some embodiments, after the carrying the synthesized multimedia information in a first session message to transmit the synthesized multimedia information to a target group, the transmitting module 4553 is configured to: perform any one of the following processing: displaying, on a session interface of the target group, the first session message carrying the synthesized multimedia information; or displaying, on a session interface of the target group, the first session message carrying the synthesized multimedia information, and displaying, on the session interface of the target group, a second session message, the second session message including an account identifier of the target object and a reminder symbol for each account identifier.

In some embodiments, after the carrying the synthesized multimedia information in a first session message to transmit the synthesized multimedia information to a target group, the apparatus further includes a commenting module, configured to: display, in response to a commenting operation by the target object on the synthesized multimedia information, comment information at a location corresponding to a target virtual avatar in the synthesized multimedia information included in the first session message; or display, in response to a commenting operation by the target object on the synthesized multimedia information, a third session message transmitted by the target object, the third session message including the synthesized multimedia information, and comment information being displayed at a location corresponding to a target virtual avatar in the synthesized multimedia information of the third session message; the target virtual avatar being a virtual avatar in the synthesized multimedia information and corresponding to the target object, and the comment information being information inputted by using the commenting operation.

In some embodiments, when the synthesized multimedia information is transmitted to the social network, before the responding to a transmitting operation for the synthesized multimedia information, the transmitting module 4553 is configured to: display a social moment editing interface in response to a completed editing operation for the synthesized multimedia information; display, in a multimedia area of the social moment editing interface, synthesized multimedia information to be transmitted; identify, in response to a trigger operation for a transmitting control, the trigger operation as a transmitting operation for the synthesized multimedia information; and display, in a text area of the social moment editing interface, an account identifier of the target object and a reminder symbol for each account identifier.

In some embodiments, when the synthesized multimedia information is transmitted to the social network, the commenting module is further configured to: display, in response to a commenting operation by the target object on the synthesized multimedia information, comment information for the synthesized multimedia information at a location of the virtual avatar corresponding to the target object on the synthesized multimedia information.

An exemplary structure of the interaction processing apparatus 455-2 provided in the embodiments of the present disclosure implemented as a software module is further described below. In some embodiments, as shown in FIG. 2, software modules in the interaction processing apparatus 455-2 stored in the memory 450 may include: a receiving module 4554, configured to receive a reminder message; a viewing module 4555, configured to display synthesized multimedia information in response to a trigger operation for the reminder message, the synthesized multimedia information including a virtual avatar of the target object; and a commenting module 4556, configured to display, on the synthesized multimedia information and in response to a commenting operation by the target object on the synthesized multimedia information, comment information corresponding to the virtual avatar of the target object.

The embodiments of the present disclosure provide a computer program product. The computer program product includes a computer-executable instruction, and the computer-executable instruction is stored in a computer-readable storage medium. A processor of an electronic device reads the computer-executable instruction from the computer-readable storage medium, and the processor executes the computer-executable instruction, to cause the electronic device to perform the interaction processing method according to the embodiments of the present disclosure.

An embodiment of the present disclosure provides a computer-readable storage medium, having a computer-executable instruction stored therein, the computer-executable instruction, when executed by a processor, causing the processor to perform the interaction processing method in the embodiments of the present disclosure, for example, the interaction processing method shown in FIG. 4A to FIG. 4D.

In some embodiments, the computer-readable storage medium may be a memory such as an FRAM, a ROM, a PROM, an EPROM, an EEPROM, a flash memory, a magnetic surface memory, an optical disk, or a CD-ROM, or may include one or any combination of the aforementioned memories.

In some embodiments, the computer-executable instruction may be written in the form of program, software, software module, script, or code in any form of programming language (including compilation or interpretation language, or declarative or procedural language), and the computer executable instructions may be deployed in any form, including being deployed as an independent program or being deployed as a module, component, subroutine, or another unit suitable for use in a computing environment.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In an example, the computer-executable instruction may, but do not necessarily, correspond to a file in a file system, and may be stored in a part of a file that saves another program or other data, for example, be stored in one or more scripts in a HyperText Markup Language (HTML) file, stored in a file that is specially configured for a program in discussion, or stored in a plurality of collaborative files (for example, be stored in files of one or more modules, subprograms, or code parts).

In an example, the computer-executable instruction may be deployed to be executed on one electronic device, on a plurality of electronic devices located at one site, or on a plurality of electronic devices distributed at a plurality of locations and connected by a communication network.

In conclusion, according to the embodiments of the present disclosure, multimedia information to be edited and a virtual avatar of at least one object are displayed, synthesized multimedia information obtained by adding a virtual avatar in a selected state to the multimedia information to be edited is displayed in response to that the at least one virtual avatar is in the selected state, which is equivalent to achieving a visual effect of being in a same frame with the virtual avatar of the object by editing the multimedia information, and subsequently a reminder message is also transmitted to the object to which the virtual avatar included in the synthesized multimedia information pertains during transmitting of the synthesized multimedia information, so as to remind the target object to view the synthesized multimedia information. That is, a reminding operation can be replaced by adding the virtual avatar. Therefore, the human-computer interaction efficiency is effectively improved while the visual effects are enriched.

The foregoing descriptions are only an embodiment of the present disclosure and are not intended to limit the scope of protection of the present disclosure. Any modification, equivalent replacement, or improvement made within the spirit and scope of the present disclosure fall within the protection scope of the present disclosure.

What is claimed is:

1. An interaction processing method, performed by an electronic device, the method comprising:
displaying multimedia information to be edited;
displaying at least one virtual avatar of at least one object;
displaying synthesized multimedia information in response to that one of the at least one virtual avatar is in a selected state, the synthesized multimedia information being obtained by adding the virtual avatar in the selected state to the multimedia information; and
transmitting the synthesized multimedia information, and transmitting a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

2. The method according to claim 1, wherein the displaying at least one virtual avatar of at least one object comprises:
displaying a selection entrance when the multimedia information to be edited is displayed;
displaying the at least one virtual avatar of the at least one object in response to a trigger operation for the selection entrance; and
the method further comprises:
displaying, for a target virtual avatar of the at least one virtual avatar, an account identifier of an object to which the target virtual avatar pertains.

3. The method according to claim 1, wherein when a plurality of virtual avatars are provided, the displaying at least one virtual avatar of at least one object comprises:
displaying the virtual avatars according to at least one of the following orders:
a temporal order starting from a time when a virtual avatar is added to the multimedia information the latest;
a descending order of frequencies at which the virtual avatars are added to the multimedia information;
a descending order of frequencies of interactions between objects corresponding to the virtual avatars and an editing object, the editing object being an object triggering the transmitting operation; or
a temporal order starting from a time when an object corresponding to a virtual avatar interacts the latest with an editing object.

4. The method according to claim 1, wherein the displaying at least one virtual avatar of at least one object comprises:
when the multimedia information to be edited comprises a candidate object, performing at least one of the following processing:
displaying a virtual avatar of the candidate object; and
displaying a virtual avatar of another object that has a social relationship with the candidate object.

5. The method according to claim 1, further comprising:
obtaining an object set;
the object set comprising an editing object and an object having a social relationship with the editing object, the editing object being an object triggering the transmitting operation, and each object in the object set having a corresponding virtual avatar; and
obtaining the virtual avatar of each object in the object set based on the object set.

6. The method according to claim 1, further comprising:
displaying, in response to a selecting operation for the at least one virtual avatar, that the at least one virtual avatar is in the selected state; or,
displaying, in response to that the at least one virtual avatar meets an adding condition, that the at least one virtual avatar is in the selected state.

7. The method according to claim 6, wherein
the adding condition comprises at least one of the following:
the virtual avatar being a virtual avatar added to the multimedia information the latest;
the virtual avatar being a virtual avatar having a highest frequency of being added to the multimedia information to be edited;
the object corresponding to the virtual avatar being an object having a highest frequency of interaction with the editing object, and the editing object being the object triggering the transmitting operation; or
the object corresponding to the virtual avatar being an object interacting the latest with the editing object.

8. The method according to claim 1, wherein the transmitting the synthesized multimedia information comprises:
carrying the synthesized multimedia information in a first session message to transmit the synthesized multimedia information to a target group, the target group comprising the at least one target object; or,
posting the synthesized multimedia information to a social network, the at least one target object having a social account of the social network.

9. The method according to claim 8, wherein further comprising:
displaying, on a session interface of the target group, the first session message carrying the synthesized multimedia information; or
displaying, on a session interface of the target group, the first session message carrying the synthesized multimedia information, and displaying, on the session interface of the target group, a second session message, the second session message comprising an account identifier of the target object and a reminder symbol for each account identifier.

10. The method according to claim 8, further comprising:
displaying, in response to a commenting operation by the target object on the synthesized multimedia information, comment information at a location corresponding to a target virtual avatar in the synthesized multimedia information comprised in the first session message; or,
displaying, in response to a commenting operation by the target object on the synthesized multimedia information, a third session message transmitted by the target object, the third session message comprising the synthesized multimedia information, and comment information being displayed at a location corresponding to a target virtual avatar in the synthesized multimedia information of the third session message;
the target virtual avatar being a virtual avatar in the synthesized multimedia information and corresponding to the target object, and the comment information being information inputted by using the commenting operation.

11. The method according to claim 1, wherein the synthesized multimedia information is transmitted to the social network, the method further comprises:
displaying a social moment editing interface in response to a completed editing operation for the synthesized multimedia information;
displaying, in a multimedia area of the social moment editing interface, synthesized multimedia information to be transmitted; and
identifying, in response to a trigger operation for a transmitting control, the trigger operation as a transmitting operation for the synthesized multimedia information; and
the method further comprises:
when displaying, in a multimedia area of the social moment editing interface, synthesized multimedia information to be transmitted, displaying, in a text area of the social moment editing interface, an account identifier of the target object and a reminder symbol for each account identifier.

12. The method according to claim 1, wherein the synthesized multimedia information is transmitted to the social network, the method further comprises:
displaying, in response to a commenting operation by the target object on the synthesized multimedia information, comment information for the synthesized multimedia information at a location of the virtual avatar corresponding to the target object on the synthesized multimedia information.

13. An electronic device, the electronic device comprising:
a memory, configured to store a computer-executable instruction; and
a processor, configured, when executing the computer-executable instruction stored in the memory, to perform:
displaying multimedia information to be edited;
displaying at least one virtual avatar of at least one object;
displaying synthesized multimedia information in response to that one of the at least one virtual avatar is in a selected state, the synthesized multimedia information being obtained by adding the virtual avatar in the selected state to the multimedia information; and
transmitting the synthesized multimedia information, and transmitting a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.

14. The device according to claim 13, wherein the displaying at least one virtual avatar of at least one object comprises:
displaying a selection entrance when the multimedia information to be edited is displayed;
displaying the at least one virtual avatar of the at least one object in response to a trigger operation for the selection entrance; and
the method further comprises:
displaying, for a target virtual avatar of the at least one virtual avatar, an account identifier of an object to which the target virtual avatar pertains.

15. The device according to claim 13, wherein when a plurality of virtual avatars are provided, the displaying at least one virtual avatar of at least one object comprises:
displaying the virtual avatars according to at least one of the following orders:
a temporal order starting from a time when a virtual avatar is added to the multimedia information the latest;
a descending order of frequencies at which the virtual avatars are added to the multimedia information;
a descending order of frequencies of interactions between objects corresponding to the virtual avatars and an editing object, the editing object being an object triggering the transmitting operation; or
a temporal order starting from a time when an object corresponding to a virtual avatar interacts the latest with an editing object.

16. The device according to claim 13, wherein the displaying at least one virtual avatar of at least one object comprises:
when the multimedia information to be edited comprises a candidate object, performing at least one of the following processing:
displaying a virtual avatar of the candidate object; and
displaying a virtual avatar of another object that has a social relationship with the candidate object.

17. The device according to claim 13, wherein the processor is further configured to perform:
obtaining an object set;
the object set comprising an editing object and an object having a social relationship with the editing object, the editing object being an object triggering the transmitting operation, and each object in the object set having a corresponding virtual avatar; and
obtaining the virtual avatar of each object in the object set based on the object set.

18. The device according to claim 13, wherein the processor is further configured to perform:
displaying, in response to a selecting operation for the at least one virtual avatar, that the at least one virtual avatar is in the selected state; or,
displaying, in response to that the at least one virtual avatar meets an adding condition, that the at least one virtual avatar is in the selected state.

19. The device according to claim 18, wherein
the adding condition comprises at least one of the following:
the virtual avatar being a virtual avatar added to the multimedia information the latest;
the virtual avatar being a virtual avatar having a highest frequency of being added to the multimedia information to be edited;
the object corresponding to the virtual avatar being an object having a highest frequency of interaction with the editing object, and the editing object being the object triggering the transmitting operation; or
the object corresponding to the virtual avatar being an object interacting the latest with the editing object.

20. A non-transitory computer-readable storage medium, having a computer-executable instruction stored therein, and the computer-executable instruction, when executed by a processor, causing the processor to perform:
displaying multimedia information to be edited;
displaying at least one virtual avatar of at least one object;
displaying synthesized multimedia information in response to that one of the at least one virtual avatar is in a selected state, the synthesized multimedia information being obtained by adding the virtual avatar in the selected state to the multimedia information; and
transmitting the synthesized multimedia information, and transmitting a reminder message to a target object in response to a transmitting operation for the synthesized multimedia information, the target object being one of the at least one object whose virtual avatar is comprised in the synthesized multimedia information, and the reminder message being configured to remind the target object to view the synthesized multimedia information.
